(19) United States
(12) Patent Application Publication
(10) Pub. No.: US 2026/0219564 A1
(43) Pub. Date: Jul. 30, 2026

(54) SYSTEM AND METHOD FOR GENERATING AN IMAGE USING A NATURAL PROJECTION MEDIUM

(71) Applicant: Disney Enterprises, Inc., Burbank, CA (US)

(72) Inventors: Jason William MONAHAN, Celebration, FL (US); Daniel Mark JOSEPH, Windermere, FL (US); Jessica Anne KLOUDA, Winter Garden, FL (US); Charles Jacob SEDOR, Orlando, FL (US)

(73) Assignee: Disney Enterprises, Inc., Burbank, CA (US)

(21) Appl. No.: 19/037,196

(22) Filed: Jan. 25, 2025

(51) Int. Cl. G03B 21/20; G03B 21/08

(52) U.S. Cl. CPC G03B 21/208; G03B 21/08; G03B 21/2013

(57) ABSTRACT

A system includes a light source configured to emit light; a lens assembly including an optical component and at least one lens; a fiber optic cable configured to transmit the light emitted from the light source to the lens assembly; an image forming layer; and a projection medium. The projection medium includes ulexite, selenite, or a combination thereof. The image forming layer is provided between the lens assembly and the projection medium.

### BACKGROUND

Special lighting and visual effects may be provided at a venue. The special lightning and visual effects may include images. In some situations, the images may be provided, to guests located at the venue, for educational purposes. In some situations, the images may be provided, to the guests located at the venue, for entertainment purposes.

### SUMMARY

In some implementations, a system includes a light source configured to emit light; a lens assembly including an optical component and at least one lens; a fiber optic cable configured to transmit the light emitted from the light source to the lens assembly; an image forming layer; and a projection medium. The projection medium includes ulexite, selenite, or a combination thereof. The image forming layer is provided between the lens assembly and the projection medium.

In some implementations, a method includes emitting light from a light source; transmitting, using a fiber optic cable, the light emitted from the light source to a lens assembly, the lens assembly comprising an optical component and at least one lens; projecting an image, using the lens assembly, on a rear surface of an image forming layer provided at a rear surface of a projection medium, the projection medium comprising ulexite, selenite, or a combination thereof; and displaying the image on a front surface of the projection medium.

### BRIEF DESCRIPTION OF THE DRAWINGS

FIG. 1A is a diagram of an example system described herein including a light source, a fiber optic cable, and a lens assembly.

FIG. 1B is a diagram of an example system described herein including a plurality of light sources, a plurality of fiber optic cables, and a plurality of lens assemblies.

FIG. 2A is a diagram of a first example of a lens assembly described herein.

FIG. 2B is a diagram of a second example of a lens assembly described herein.

FIG. 2C is a diagram of a third example of a lens assembly described herein.

FIG. 3 is a diagram of example optical components described herein.

FIG. 4 is a diagram of an example implementation of the system of FIG. 1A or 1B used in conjunction with an outdoor structure described herein.

FIG. 5 is a diagram of an example implementation of the system of FIG. 1B used in conjunction with an outdoor structure described herein.

FIG. 6 is a diagram of example components of one or more devices of FIG. 1A or 1B.

### DETAILED DESCRIPTION

The following detailed description of example implementations refers to the accompanying drawings. The same reference numbers in different drawings may identify the same or similar elements.

Special lighting and visual effects may be provided at a venue that includes one or more guests. The special lightning and visual effects may include images that are animated. Traditionally, providing the images would require an embedded video screen or video projectors to create the images with a satisfactory resolution or measure of quality (e.g., a measure of quality that would satisfy a guest experience). Fiber optics have been used to animate images. Fiber optics require multiple fiber optic cables, with each fiber optic cable creating a single point of light in a larger image. For example, a fiber optic star ceiling may be created with each point of light being a single star in a constellation.

Using embedded video screens or video projectors requires the use of multiple additional electrical components and, accordingly, requires configuring the videos screens, the video projectors, and the additional electrical components to enable communication between the aforementioned devices. Accordingly, using embedded video screens or video projectors is a time consuming option (e.g., due to the requirement to configure the aforementioned devices). Additionally, using embedded video screens or video projectors consumes a significant amount of electrical resources (e.g., to power the aforementioned devices) and a significant amount of bandwidth (e.g., to enable communication between the aforementioned device).

In some situations, a request may be submitted (e.g., by a guest, an administrator, or any other person at the venue) to provide the images in an outdoor environment that is subjected to moisture, such as rain and flowing water. For example, the request may be submitted to incorporate the images in a water fountain. However, providing the images using video screens and video projectors in an outdoor environment subject to moisture may be a complex and time consuming task.

For at least the foregoing reasons, there is a need for a system that enables animation, visible in daylight, in an outdoor environment in direct contact with moisture (e.g., humidity, rain, water, etc.). The system may be concealed within decorative elements, such as rockwork or tilework. This system may present the animation in a way that the animation appears to blend seamlessly with the outdoor environment (e.g., be part of the surrounding rockwork, tilework, or landscape).

In some implementations, the system may include a controllable light source, a lens assembly connected to the controllable light source via fiber optic cables, an image forming layer, and a projection medium.

To create an image within the rockwork or tilework, the system may include the projection medium, such as Selenite and/or Ulexite (also referred to as “TV stone”). The projection medium comprises crystal fibers with optical properties that enable an image provided on (or projected onto) a rear surface of the projection medium to appear on a front surface of the projection medium. The projection medium may be embedded within the rockwork or tilework.

The image forming layer may include rear projection material. The image forming layer may be provided between the projection medium (i.e., at a rear surface of the projection medium) and the lens assembly. The image forming layer is a surface upon which an image projected by an optical component of the lens assembly may be formed/focused on. In examples where the projection medium is Selenite and/or Ulexite, if the image forming layer was not present, an observer would only see light passing through the projection medium, as opposed to seeing an image on the front surface of the projection medium.

In some examples, the lens assembly may include one or more lenses and an optical component. The optical component may include a thin piece of material, such as a sheet of plastic or a sheet of glass, without limitation. An image may be printed on the optical component, may be painted on the optical component, or otherwise formed on the optical component. As an example, the optical component may include a gobo (“Go Between Optics”). The optical component may be placed in front of the light source to define a shape of light emitted by the light source. In this regard, the optical component may operate as a mask with a shape or a pattern, among other examples. The optical component may include translucent or transparent material, such as a sheet of glass or a plastic. In some implementations, the optical component may have a 10 mm outer diameter, may have a 6 mm image area, and/or may be 1 mm thick.

In some examples, the lens assembly may be included in a hollow cavity behind the image forming layer. The lens assembly may include one or more lenses that enable the image to be placed at a focal distance and enable a size of the image (projected onto the image forming layer) to be adjusted. In some examples, a mechanical manipulation of the lens assembly may vary a distance and an orientation of the one or more lenses with respect to the image forming layer. In some implementations, a size and a location of the image may also be adjusted via mechanical manipulation of lens assemblies described herein, such as by varying distances and orientations of the lens assemblies. In some implementations, the focal distance may be pre-determined (e.g., at a time of manufacture of the lens assemblies).

In some implementations, the optical component (e.g., gobo) may be illuminated by the light source using a strand of fiber optic cables, thereby forming a still image on the projection medium. In some implementations, multiple optical components, light sources, and fiber optical cables may be used to create a series of animations on the projection medium. For example, a first optical component may be illuminated by a first light source using a first fiber optic cable, and a second optical component may be illuminated by a second light source using a second fiber optic cable. By illuminating different optical components using separate light sources, a visibility of a first image (projected using the first optical component and the first light source) may be controlled separately from a visibility of a second image (projected using the second optical component and the second light source).

By controlling an intensity of a light source to cause the light source to fade on and off or cause the light source to turn on and off, an image may appear or disappear. By alternating between two or more images (each projected using a respective optical component and a respective light source), the series of animations may be created (e.g., an animation of a person, character, or object moving). These animations of multiple images may be created with two or more images aligned so that the animated image appears to be moving in place, or the projected images can be offset from one another to create a series of movements across the projection medium.

The system described herein provide several advantages. One advantage of using fiber optic cables is to enable the light source to be placed in a remote location (e.g., remote from an outdoor environment in which the projection medium and lens assembly are located). For example, the light source may be located in an electrical equipment room or in a weather resistant enclosure located remotely with respect to the projection medium and the lens assembly. By enabling the light source to be located remotely, electrical components may not be required in an installation area of the projection medium and the lens assembly.

The projection medium and the lens assembly may be sealed within an environment (e.g., rockwork or tilework of an outdoor environment) without a need for regular maintenance access. As an example, the projection medium and the lens assembly may be provided in a weatherproof enclosure. In some examples, the lens assembly may be provided in an enclosure within the weatherproof enclosure.

In some examples, the fiber optic cables may be thin fiber optic cables, such as fiber optic cables with a diameter of three millimeters, two and a half millimeters, one and a half millimeters, and one millimeter, among other examples. In this regard, the use of thin fiber optic cables may require less space than regular lighting cables. Additionally, the use of thin fiber optic cables may be for aesthetic and/or safety considerations when placing the lens assembly and the projection medium in an outdoor environment. Typically, a cooling system (e.g., a fan) may be used to reduce a temperature of the light source. Accordingly, another advantage of the system described herein is to avoid providing additional equipment (e.g., the cooling system) in the installation area. Accordingly, the system described herein may preserve space, in the installation area, that would been used for the cooling system.

In some implementations, the light source may be controlled using programming internal to the light source or controlled as a part of a larger lighting system. For example, the light source may be programmed to emit light at different intensities at different periods of time. Additionally, or alternatively, the light source may be programmed using a controller.

The system described herein creates a new type of animation surface in a way that seamlessly blends with surroundings of the system (e.g., a rockwork or a tilework). With a reduced size compared to a conventional projection system or a liquid crystal display (LCD) based system, the system described herein requires less maintenance and less space than conventional projection or LCD based systems. The system described herein is also less expensive to install than the conventional projection or LCD based systems.

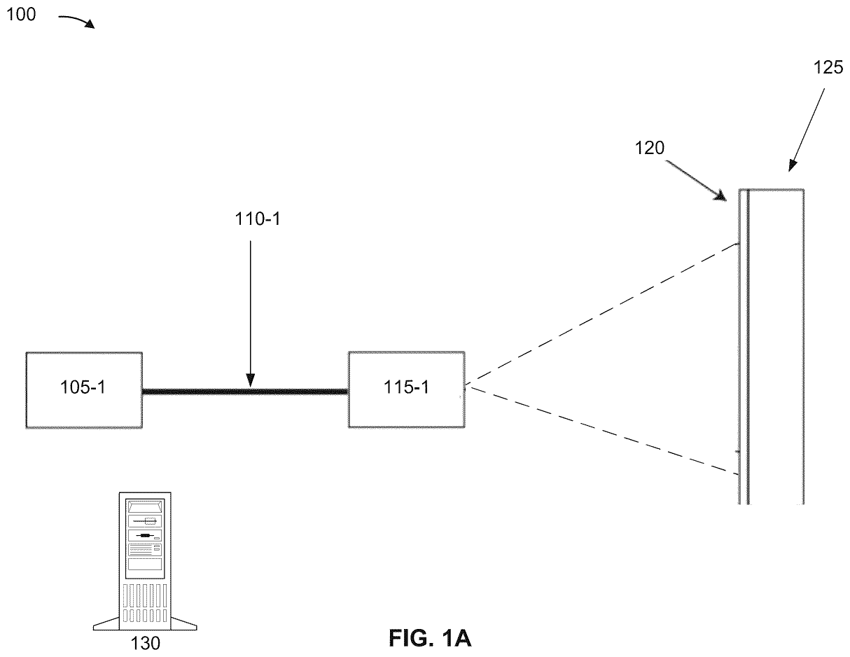

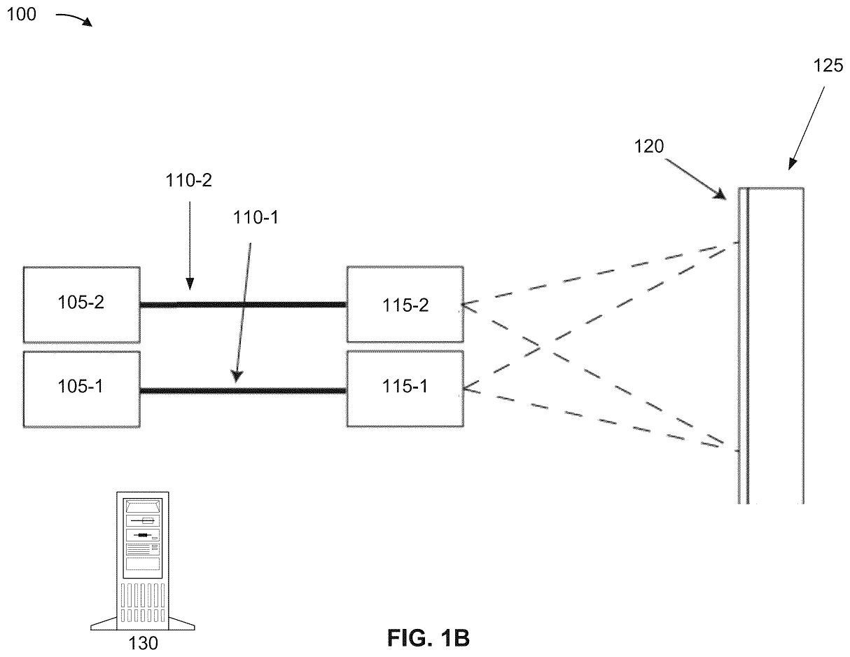

FIGS. 1A and 1B are diagrams of an example system 100 described herein. As shown in FIG. 1A, in some implementations, system 100 may include a first light source 105-1, a first fiber optic cable 110-1, a first lens assembly 115-1, an image forming layer 120, a projection medium 125, and a controller 130. As shown in FIG. 1B, in some implementations, system 100 may include first light source 105-1, a second light source 105-2, first fiber optic cable 110-1, a second fiber optic cable 110-2, first lens assembly 115-1, a second lens assembly 115-2, image forming layer 120, projection medium 125, and controller 130. In some implementations, first light source 105-1, second light source 105-2, and controller 130 may be connected via wired and/or wireless connections. In this regard, first light source 105-1, second light source 105-2, and controller 130 communicate with each other via the wired and/or the wireless connections.

First light source 105-1 may emit and transmit first light to first lens assembly 115-1 via first fiber optic cable 110-1. Second light source 105-2 may emit and transmit second light to second lens assembly 115-2 via second fiber optical cable 110-2. First light source 105-1 and/or second light source 105-2 may be a controllable light source. For example, an intensity of the light may be independently controlled between a lowest intensity (e.g., lowest brightness) and a highest intensity (e.g., a highest brightness). First light source 105-1 and/or second light source 105-2 may emit bright light. For example, first light source 105-1 and/or second light source 105-2 may emit light with a sufficient amount of intensity to be transmitted by first fiber optic cable 110-1 and second fiber optic cable 110-2, respectively, to brightly illuminate images formed on optical components of lens assemblies described herein. First light source 105-1 and/or second light source 105-2 may emit light in the invisible light spectrum (i.e., light having a wavelength invisible to the human eye). In some examples, first light source 105-1 and/or second light source 105-2 may emit infrared light. In some implementations, first light source 105-1 and/or second light source 105-2 may be a white laser light module (e.g., a laser emitting white light in the invisible light spectrum). First light source 105-1 and/or second light source 105-2 may be referred to as a fiberoptic illuminator. In some examples, first light source 105-1 and/or second light source 105-2 may be a same type of light source (e.g., emitting the same type of light). In some examples, first light source 105-1 and/or second light source 105-2 may be different types of light sources (e.g., emitting different types of light).

First fiber optic cable 110-1 optically couples first light source 105-1 and first lens assembly 115-1. In this regard, first fiber optic cable 110-1 may transmit the first light emitted by first light source 105-1 to first lens assembly 115-1. The first light may be a beam of light that is narrow, such that a majority of the first light is transmitted via the first fiber optic cable 110-1 to illuminate an optical component. Second fiber optic cable 110-2 optically couples second light source 105-2 and second lens assembly 115-2. In this regard, second fiber optic cable 110-2 may transmit the second light emitted by second light source 105-2 to second lens assembly 115-2. The second light may be a beam of light that is narrow, such that a majority of the second light is transmitted via the second fiber optic cable 110-2 to illuminate an optical component. In some examples, first fiber optic cable 110-1 and/or second fiber optic cable 110-2 may be tens of feet long. Accordingly, first fiber optic cable 110-1 may enable first light source 105-1 to be located remotely from first lens assembly 115-1 (e.g., tens of feet away). Additionally or alternatively, second fiber optic cable 110-2 may enable second light source 105-2 to be located remotely from second lens assembly 115-2 (e.g., tens of feet away). In this regard, first lens assembly 115-1 and/or second lens assembly 115-2 may be located in a first location, and first light source 105-1 and/or second light source 105-2 may be located in a second location different from the first location. As an example, the first location may be an outdoor environment and the second location may be an indoor environment (e.g., an equipment room). As another example, the first location may be a first room in which observers of a presentation displayed by system 100 are located, and the second location may be a second room.

First lens assembly 115-1 may include an optical component and one or more lenses. In some implementations, the first light emitted from first light source 105-1 may illuminate the optical component to generate a first image. The first image may be generated based on a shape formed by the optical component or based on a pattern formed by the optical component. In some situations, the one or more lenses may increase a width of the first light to enable the first light to illuminate a significant portion of the optical component (e.g., to illuminate a majority of the optical component). Second lens assembly 115-2 may be similar to first lens assembly 115-1.

Although FIG. 1B illustrates two light sources, two lens assemblies, and two fiber optic cables, in other examples, there may be different numbers of each element present. In one example, there may be one light source optically coupled to one lens assembly via one fiber optic cable. In other examples, there could be three or more light sources, lens assemblies, and fiber optic cables, provided each light source is optically coupled to a respective lens assembly via a respective fiber optic cable.

Image forming layer 120 may include a transparent and rigid material that receives and reproduces an image projected by illuminating the optical component. The image may be included on the optical component and may be projected by illuminating the optical component. The image may be focused by a lens (of the lens assembly) prior to being transmitted to/projected on image forming layer 120. Image forming layer 120 is provided at a rear surface of projection medium 125 (e.g., a TV stone material). The image projected on image forming layer 120 may be displayed on a front surface of projection medium 125 due to the optical properties of projection medium 125. In some examples, image forming layer 120 may include a thin layer of rear projection material. In some examples, image forming layer 120 may include material, such as a glass material, a plastic material, among other examples of material that may be used to implement rear projection. In some examples, image forming layer 120 may be a diffusive surface that is rigid and that enables rear projection.

In some examples, image forming layer 120 may create a diffusive surface that allows the image to form. A diffusive surface scatters projected light and may allow a projected image (e.g., a first image projected by first lens assembly 115-1 or a second image projected by second lens assembly 115-2) to have a surface upon which to form. In particular, when the projected light contacts the diffusive surface and scatters, the image is consequently formed. In other examples, image forming layer 120 may create a regular or specular surface. In some examples, image forming layer 120 may include a finish selected to produce a desired effect. In one example, the finish may be a black finish configured to create better contrast. In another example, the finish may be a white finish configured to produce a brighter image. Image forming layer 120 may transmit the image to projection medium 125.

Projection medium 125 may include a rear surface and a front surface. The rear surface may refer to a surface that faces the one or more lens assemblies. The front surface may refer to a surface that faces an observer of a presentation by system 100. In some examples, projection medium 125 includes TV stone material having a fibrous structure capable of transmitting light along the fibers through internal reflection. Thus, an image (e.g., first image) received at the rear surface of projection medium 125 may be seen at the front surface of projection medium 125. In some examples, projection medium 125 may include ulexite, selenite, or a combination thereof. In some implementations, projection medium 125 may be embedded within a structure. The structure may include a natural structure or a man-made structure, such as rockwork, brickwork, tilework, among other examples. In some situations, projection medium 125 may be encapsulated in a sealant to prevent environmental factors (e.g., rain, snow, dust) from damaging projection medium 125 and inhibiting optical qualities of projection medium 125. In some situations, projection medium 125 may be encapsulated in the sealant for aesthetic reasons.

Controller 130 may be programmed to control an operation of first light source 105-1 and/or second light source 105-2. For example, controller 130 may be programmed to independently control an intensity of first light source 105-1 and second light source 105-2. As an example, controller 130 may control the intensity to fade between two images (e.g., one image being generated using first light source 105-1 and another image being generated using second light source 105-2). For example, controller 130 may cause one image (generated using first light source 105-1) to gradually disappear while another image (generated using second light source 105-2) gradually appears. As an example, one image may be an image of a butterfly opening its wings and another image may be an image of the butterfly closing its wings. By fading between the two images, controller 130 may create an animation of the butterfly flying or flapping its wings. As another example, controller 130 may cause one image (generated using first light source 105-1) to disappear (e.g., immediately disappear) and another image (generated using second light source 105-2) to appear (e.g., immediately appear). For example, controller 130 may turn off first light source 105-1 and turn on second light source 105-2, and vice versa. In some implementations, controller 130 may include a digital multiplex (DMX) controller.

The number and arrangement of devices shown in FIGS. 1A and 1B are provided as an example. In practice, there may be additional devices, fewer devices, different devices, or differently arranged devices than those shown in FIGS. 1A and 1B. For example, system 100 may include three or more light sources, lens assemblies, and fiber optic cables, provided each light source is optically coupled to a respective lens assembly via a respective fiber optic cable.

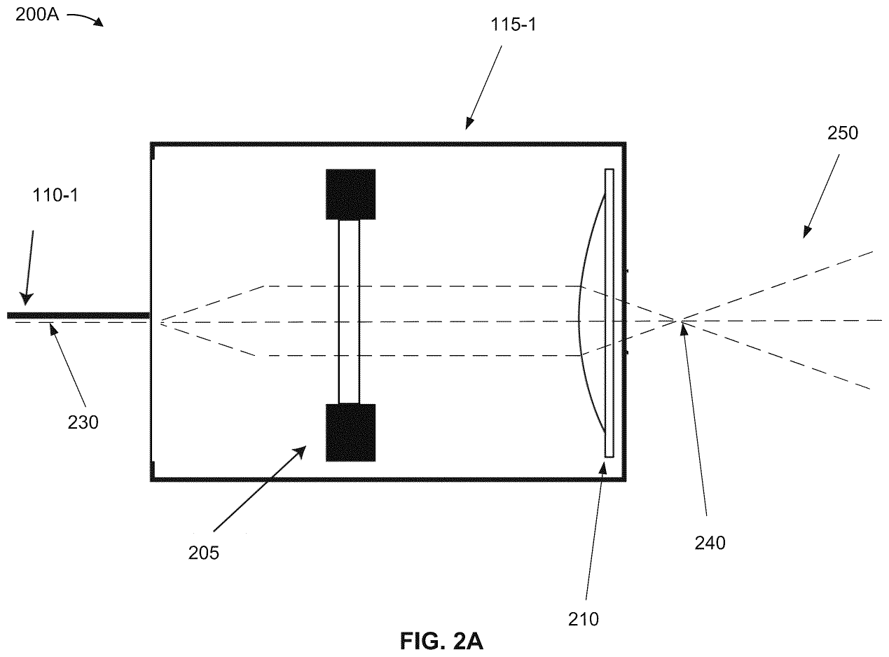

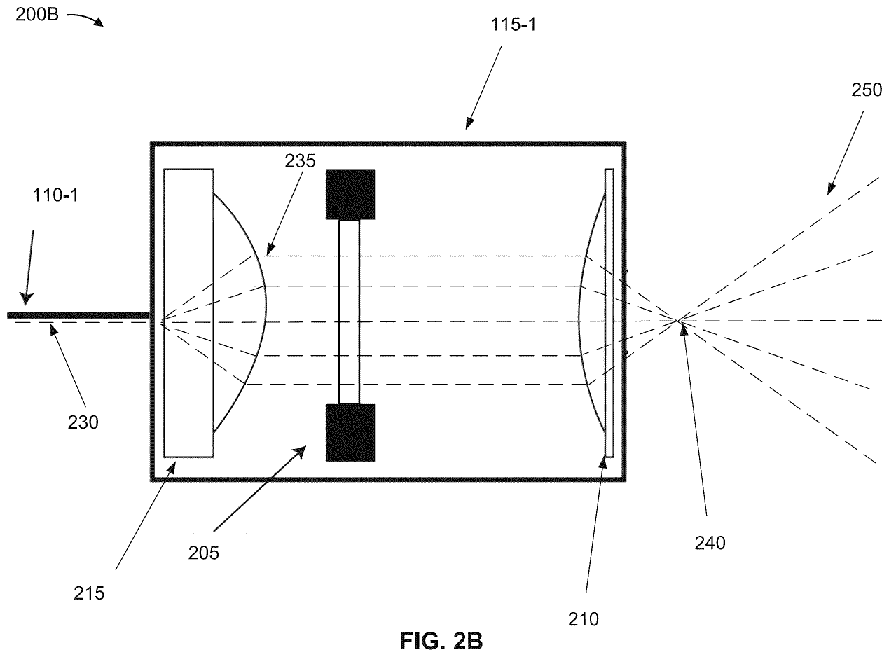

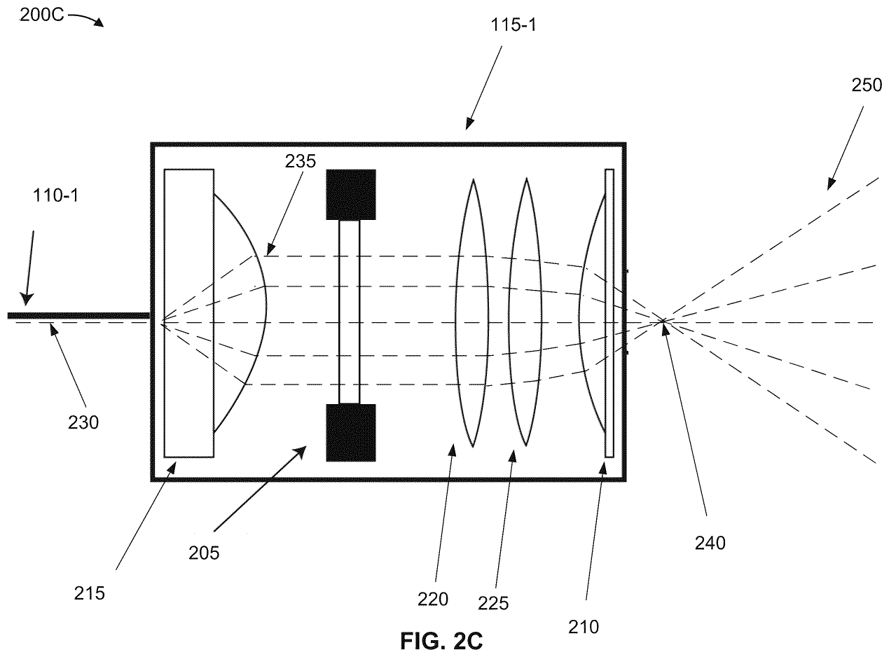

FIGS. 2A-2C are diagrams of an examples of a lens assembly described herein.

As shown in FIG. 2A, in a first example 200A, first lens assembly 115-1 may include an optical component 205 and a first lens 210. As shown in FIG. 2B, in a second example 200B, first lens assembly 115-1 may additionally include a second lens 215. In this regard, second lens 215 may be optional. Optical component 205 may be provided between second lens 215 and first lens 210. As shown in FIG. 2C, in a third example 200C, first lens assembly 115-1 may additionally include third lens 220 and/or a fourth lens 225 provided between first lens 210 and second lens 215. In this regard, third lens 220 and/or fourth lens 225 may be optional. First lens 210, second lens 215, third lens 220, and/or fourth lens 225 may enable the first image (generated using first lens assembly 115-1) to be placed at a pre-determined or selected focal distance and may enable a size of the first image (projected onto image forming layer 120) to be adjusted. In some implementations, the focal distance may be adjusted via mechanical manipulation of first lens assembly 115-1, such as by varying distances and orientations of the lenses. In some implementations, the focal distance may be pre-determined (e.g., at a time of manufacture of first lens assembly 115-1). In some implementations, first lens 210, second lens 215, third lens 220, and/or fourth lens 225 may include a convex lens.

In some implementations, referring back to FIG. 2B, second lens 215 may include a convex lens that increases a width of a light beam of the first light transmitted from first light source 105-1 via first fiber optic cable 110-1. By increasing the width of the light beam, second lens 215 may cause the first light to illuminate a substantial portion of optical component 205 (e.g., at least 70% of optical component 205). Second lens 215 may ensure that the first light, from first fiber optic cable 110-1, is wide enough to cover an entire or substantial portion of a rear surface (i.e., a surface facing second lens 215) of optical component 205. In some examples, second lens 215 creates parallel beams of light 235 to evenly illuminate optical component 205. In some examples, second lens 215 may include a plano convex lens.

Optical component 205 may include a transparent film or substrate (e.g., a glass or a plastic material) having an image painted, printed, or otherwise provided thereon. The image may depict one or more shapes, patterns, objects, characters, people, text, or logos. Optical component 205 may project the image when illuminated by the first light. In some examples, the entire image is provided on optical component 205. In other examples, in which the image includes negative space, portions of the image (as opposed to the whole image) may be provided on optical component 205.

Optical component 205 may have any shape, such as a circular shape or a rectangular shape, among other examples. As an example, optical component 205 may be a quarter of an inch to a half inch in diameter. In some implementations, optical component 205 may be a gobo. The gobo may be made, for example, of metal (e.g., steel) or glass. The gobo may have the image stenciled on, etched, or cut out of the gobo material such that first light is only permitted to pass through certain portions of the gobo (e.g., areas that are stenciled, etched, or cut out), thereby producing the image.

In some implementations, as shown in FIG. 2C, third lens 220 and fourth lens 225 may be provided to adjust a focus of the image. In some examples, third lens 220 and fourth lens 225 may be convex lenses. In some examples, third lens 220 and fourth lens 225 may be biconvex converging lenses configured to increase a size of the image and adjust the focus of the image. In one implementation, at least one of third lens 220 or fourth lens 225 may be excluded.

Referring to now FIGS. 2A-2C, first lens 210 may include a convex lens (e.g., a plano convex lens). For example, first lens 210 may increase a size of the image projected by optical component 205. First lens 210 may increase the size of the image to enable the size of the image to cover a substantial portion of image forming layer 120 and/or projection medium 125. In order to achieve a desired size of the image, first lens 210 may be provided at a pre-determined or selected focal distance from optical component 205. In some implementations, first lens 210 may focus light to a focal point 240. In some examples, focal point 240 may be provided one or more inches from first lens assembly 115-1. In some implementations, first lens 210 may operate in a manner similar to a manner in which a lens of a video projector operates.

As shown in FIGS. 2A-2C, first lens assembly 115-1 may receive first light 230 from first light source 105-1 via first fiber optic cable 110-1. First lens assembly 115-1 may transmit first light 230 as first transmitted light 250. First transmitted light 250 may form the image on the rear surface of image forming layer 120 (not shown). The image may be transmitted to projection medium 125. Second lens assembly 115-2 (not shown) may include components similar to the components included in first lens assembly 115-1.

The number and arrangement of devices shown in FIGS. 2A-2C are provided as an example. In practice, there may be additional devices, fewer devices, different devices, or differently arranged devices than those shown in FIGS. 2A-2C. For example, lens assembly 115-1 may include or exclude one or more of second lens 215, third lens 220, or fourth lens 225.

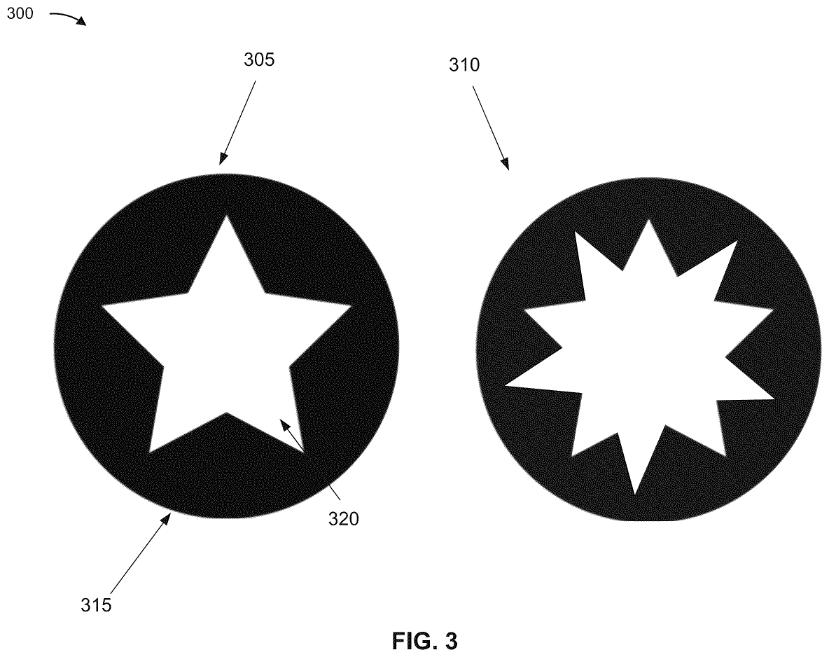

FIG. 3 is a diagram of an example 300 of optical components used in a lens assembly described herein. As shown in FIG. 3, implementation 300 may include first optical component 305 and second optical component 310. First optical component 305 and second optical component 310 may be operated in a manner similar to the operation of optical component 205. In some examples, first optical component 305 and second optical component 310 may include gobos.

In some examples, first optical component 305 may be included in first lens assembly 115-1 and second optical component 310 may be included in second lens assembly 115-2. As shown in FIG. 3, first optical component 305 may depict a first star. In other words, a shape of a star may be provided on first optical component 305. As shown in FIG. 3, second optical component 310 may depict a second star. In some examples, a star of a different shape may be provided on second optical component 310. In some examples, second optical component 310 may depict a same star as first optical component 305, but in an orientation that is different than an orientation of the star of first optical component 305.

As controller 130 controls an intensity of the first light emitted from first light source 105-1 and an intensity of the second light emitted from second light source 105-2, first optical component 305 and second optical component 310 may be successively illuminated. As the first light illuminates first optical component 305, a first image of the first star may be formed on image forming layer 120. In this regard, first optical component 305 may include a first portion 315 that blocks light and a second portion 320 that allows light to pass. By blocking light and allowing light to pass, first portion 315 and second portion 320 may enable the first image of the first star to be formed.

Similarly to the first light illuminating first optical component 305, as the second light illuminates second optical component 310, a second image of the second star may be formed on image forming layer 120. In some implementations, controller 130 may cause the first light and the second light to fade on and off, thereby causing the first image and the second image to gradually appear or disappear such that only one of the first image or the second image are visible or both the first image and the second image are visible. By fading on and off between two images, a series of animations may be created (e.g., an animation of a star glimmering). In some implementations, controller 130 may cause the first light and the second light to alternatively turn on and off, thereby causing the first image and the second image to successively appear or disappear. By alternating between two images, a series of animations may be created (e.g., an animation of a star glimmering).

In some implementations, first optical component 305 may include a pattern, such as a color, a design, among other examples. In this regard, illuminating first optical component 305 may cause the painted pattern to be formed on image forming layer 120.

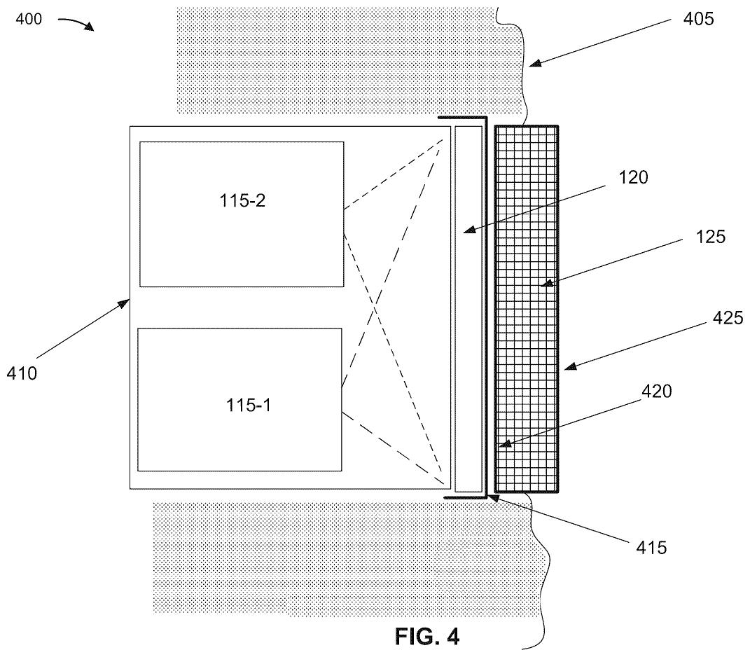

FIG. 4 is a diagram of an example implementation 400 of the system of FIG. 1B used in conjunction with an outdoor structure, as described herein. Some elements of implementation 400 have been described above in connection with FIGS. 1A and 1B. As shown in FIG. 4, implementation 400 includes first lens assembly 115-1, second lens assembly 115-2, image forming layer 120, and projection medium 125.

As shown in FIG. 4, implementation 400 may include an outdoor structure 405 and an enclosure 410. Outdoor structure 405 may include rockwork, brickwork, or tilework, among other examples. As shown in FIG. 4, projection medium 125 may be incorporated into (or embedded within) outdoor structure 405. Projection medium 125 may be incorporated into outdoor structure 405 such that projection medium 125 appears to be part of outdoor structure 405. For example, projection medium 125 may blend in with outdoor structure 405. In some examples, a color and/or a texture of projection medium 125 may be selected to match a color and/or a texture of outdoor structure 405. Alternatively, a frame may be provided around a perimeter of projection medium 125, where the frame may be selected to match a color and/or a texture of outdoor structure 405.

First lens assembly 115-1 and second lens assembly 115-2 may be included in enclosure 410. Enclosure 410 may include a weatherproof enclosure. In some examples, implementation 400 may include a sealing component 415 that provides a seal for enclosure 410. As shown in FIG. 4, sealing component 415 may provide a seal to image forming layer 120. In this regard, sealing component 415 may protect first lens assembly 115-1, second lens assembly 115-2, and image forming layer 120 from moisture conditions of an outdoor environment. Sealing component 415 may include an acrylic material or a glass material. In some examples, sealing component 415 may be optically and mechanically bonded to projection medium 125 to increase strength of sealing component 415 and/or enhance image fidelity displayed by projection medium 125.

As shown in FIG. 4, projection medium 125 may include a rear surface 420 and a front surface 425. As explained herein, image forming layer 120 may form an image and project the image onto rear surface 420 of projection medium 125. Based on the composition and properties of projection medium 125, the image may be provided on front surface 425 of projection medium 125.

The number and arrangement of devices shown in FIG. 4 are provided as an example. In practice, there may be additional devices, fewer devices, different devices, or differently arranged devices than those shown in FIG. 4. For example, in some implementations, second lens assembly 115-2 may be excluded. In other implementations, more than two lens assemblies may be included.

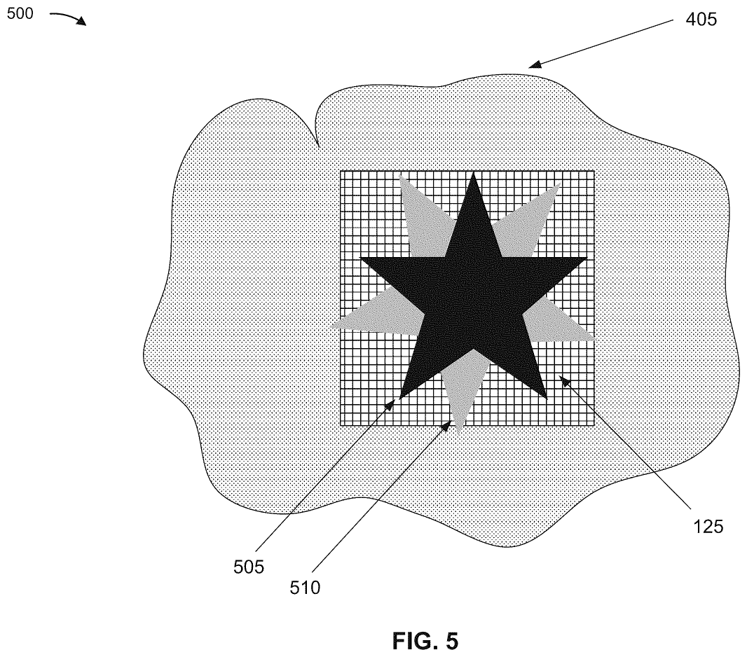

FIG. 5 is a diagram of an example implementation 500 of the system of FIG. 1B used in conjunction with an outdoor structure 405 described herein. In some examples, outdoor structure 405 may be rockwork, brickwork, or tilework included, for example, in a water fountain. In this regard, outdoor structure 405 and projection medium 125 may be subjected to a continuous flow of water.

As shown in FIG. 5, projection medium 125 may display a first image 505 and a second image 510. In this regard, projection medium 125 may display first image 505 as a result of first optical component 305 being illuminated by the first light (e.g., first light 230) from first light source 105-1, as explained herein. Similarly, projection medium 125 may display second image 510 as a result of second optical component 310 being illuminated by the second light from second light source 105-2.

As shown in FIG. 5, controller 130 may cause the first light to fade on and the second light to fade off, thereby causing first image 505 to gradually appear and second image 510 to gradually disappear. By fading on and off between two images, a series of animations may be created (e.g., an animation of a star glimmering). In some implementations, controller 130 may cause the first light and the second light to alternately turn on and turn off, thereby causing first image 505 to appear (e.g., immediately appear) and second image 510 to disappear (e.g., immediately disappear) such that only one image is visible at a time.

The number and arrangement of devices shown in FIG. 5 are provided as an example. In practice, there may be additional devices, fewer devices, different devices, or differently arranged devices than those shown in FIG. 5. In some examples, projection medium 125 may display only one image. In other examples, projection medium 125 may display more than two images.

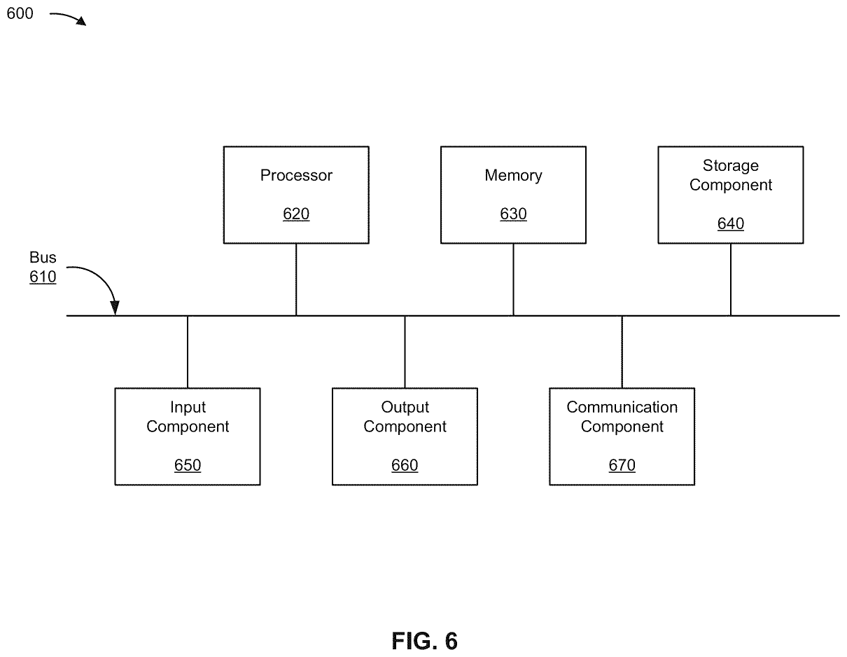

FIG. 6 is a diagram of example components of a device 600, which may correspond to one or more devices of FIG. 1A or 1B (e.g., light sources 105 and/or controller 130). As shown in FIG. 6, device 600 may include a bus 610, a processor 620, a memory 630, a storage component 640, an input component 650, an output component 660, and a communication component 670.

Bus 610 includes a component that enables wired and/or wireless communication among the components of device 600. Processor 620 includes a central processing unit, a graphics processing unit, a microprocessor, a controller, a microcontroller, a digital signal processor, a field-programmable gate array, an application-specific integrated circuit, and/or another type of processing component. Processor 620 is implemented in hardware, firmware, or a combination of hardware and software. In some implementations, processor 620 includes one or more processors capable of being programmed to perform a function. Memory 630 includes a random access memory, a read only memory, and/or another type of memory (e.g., a flash memory, a magnetic memory, and/or an optical memory).

Storage component 640 stores information and/or software related to the operation of device 600. For example, storage component 640 may include a hard disk drive, a magnetic disk drive, an optical disk drive, a solid state disk drive, a compact disc, a digital versatile disc, and/or another type of non-transitory computer-readable medium. Input component 650 enables device 600 to receive input, such as guest input and/or sensed inputs. For example, input component 650 may include a touch screen, a keyboard, a keypad, a mouse, a button, a microphone, a switch, a sensor, a global positioning system component, an accelerometer, a gyroscope, and/or an actuator. Output component 660 enables device 600 to provide output, such as via a display, a speaker, and/or one or more light-emitting diodes. Communication component 670 enables device 600 to communicate with other devices, such as via a wired connection and/or a wireless connection. For example, communication component 670 may include a receiver, a transmitter, a transceiver, a modem, a network interface card, and/or an antenna.

Device 600 may perform one or more processes described herein. For example, a non-transitory computer-readable medium (e.g., memory 630 and/or storage component 640) may store a set of instructions (e.g., one or more instructions, code, software code, and/or program code) for execution by processor 620. Processor 620 may execute the set of instructions to perform one or more processes described herein. In some implementations, execution of the set of instructions, by one or more processors 620, causes the one or more processors 620 and/or the device 600 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 6 are provided as an example. Device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system, comprising:
a light source configured to emit light;
a lens assembly comprising an optical component and at least one lens;
a fiber optic cable configured to transmit the light emitted from the light source to the lens assembly;
an image forming layer; and
a projection medium comprising ulexite, selenite, or a combination thereof,
wherein the image forming layer is provided between the lens assembly and the projection medium.

2. The system of claim 1, wherein the image forming layer comprises a diffusive surface.

3. The system of claim 1, wherein the optical component comprises a go between optics (gobo) including an image, wherein the light transmitted by the fiber optic cable to the lens assembly is only permitted to pass through a portion of the gobo including the image, thereby projecting the image on the image forming layer.

4. The system of claim 1, wherein the at least one lens comprises a first lens provided between the optical component and the image forming layer.

5. The system of claim 4, wherein:
the at least one lens further comprises a second lens provided between the fiber optic cable and the optical component, and
the second lens comprises a convex lens.

6. The system of claim 1, wherein the lens assembly is located at a first location and the light source is located at a second location remote from the first location.

7. The system of claim 6, wherein the first location is an outdoor location, and the second location is an indoor location.

8. The system of claim 1, further comprising:
a second light source configured to emit second light;
a second lens assembly comprising a second optical component and at least one second lens; and
a second fiber optic cable configured to transmit the second light emitted from the second light source to the second lens assembly.

9. The system of claim 8, wherein:
the optical component comprises a go between optics (gobo) including a first image,
the second optical component comprises a second gobo including a second image, the second image being different from the first image.

10. The system of claim 8, further comprising a controller programmed to independently control an intensity of the light emitted from the light source and an intensity of the second light emitted from the second light source.

11. A method, comprising:
emitting light from a light source;
transmitting, using a fiber optic cable, the light emitted from the light source to a lens assembly, the lens assembly comprising an optical component and at least one lens;
projecting an image, using the lens assembly, on a rear surface of an image forming layer provided at a rear surface of a projection medium, the projection medium comprising ulexite, selenite, or a combination thereof; and
displaying the image on a front surface of the projection medium.

12. The method of claim 11, wherein the image forming layer comprises a diffusive surface.

13. The method of claim 11, wherein:
the optical component comprises a go between optics (gobo) including the image, and
projecting the image comprises permitting the light to pass through a portion of the gobo including the image.

14. The method of claim 11, wherein the lens assembly is located at a first location and the light source is located at a second location remote from the first location.

15. The method of claim 14, wherein the first location is an outdoor location, and the second location is an indoor location.

16. The method of claim 11, further comprising:
emitting a second light from a second light source; and
transmitting, using a second fiber optic cable, the second light emitted from the second light source to a second lens assembly, the second lens assembly comprising a second optical component and at least one second lens; and
projecting a second image, using the second lens assembly, on the rear surface of the image forming layer; and
displaying the second image on the front surface of the projection medium.

17. The method of claim 16, wherein:
the optical component comprises a go between optics (gobo) including a first image,
the second optical component comprises a second gobo including a second image, the second image being different from the first image,
projecting the first image comprises permitting the light to pass through a portion of the gobo including the first image, and
projecting the second image comprises permitting the second light to pass through a portion of the second gobo including the second image.

18. The method of claim 16, further comprising independently controlling, using a programmable controller, an intensity of the light emitted from the light source and an intensity of the second light emitted from the second light source.

19. The method of claim 18, further comprising selectively displaying the image or the second image on the front surface of the projection medium by using the programmable controller to (i) turn the light source on and the second light source off to project and display the first image, and (ii) turn the light source off and the second light source on to project and display the second image.

20. The method of claim 19, wherein the first image is displayed at a first location on the front surface of the projection medium, and the second image is displayed at a second location on the front surface of the projection medium offset from the first location such that sequentially displaying the first image and the second image creates a movement effect across the projection medium.
